(19) United States
(12) Patent Application Publication
(10) Pub. No.: US 2010/0319018 A1
(43) Pub. Date: Dec. 16, 2010

(54) Directing Interactive Content

(76) Inventor: Frank Zazza, New Rochelle, NY (US)

Correspondence Address: PATENTFORGE, 1725 SE 72ND, PORTLAND, OR, 97215, US

(21) Appl. No.: 12/504,663

(22) Filed: Jul. 17, 2009

Related U.S. Application Data
(60) Provisional application No. 61/222,873, filed on Jul. 2, 2009.
(60) Provisional application No. 61/186,764, filed on Jun. 12, 2009.

(51) Int. Cl. H04N 7/025; H04N 5/445; H04N 7/173

(52) U.S. Cl. 725/32; 725/60; 725/87

(57) ABSTRACT

An entertainment capsule is described which includes at least one viewer selectable icon and content. The viewer selectable icon may be displayed simultaneously with entertainment segments. Entertainment capsule content may be sequenced to be displayed at a later time in response to viewer selection of the icon.

### RELATED APPLICATIONS

This application claims priority to U.S. Provisional Application Ser. No. 61/222,873 filed Jul. 2, 2009 titled “Directing Interactive Advertising” and U.S. Provisional Application Ser. No. 61/186,764 filed Jun. 12, 2009 titled “Enhanced Viewer Interaction for Programming” which are hereby incorporated by reference in their entirety for all purposes.

### BACKGROUND

The present disclosure relates generally to interactive video and more specifically to interactive on-demand or broadcast video displaying selectable tags associated with additional video content.

### SUMMARY

Television for most of its existence has been a one way medium. Programming is presented to the viewer and the viewer is limited to selecting channels. The VCR allowed viewers to access programming at a time of their choosing and Tivo now predicts viewer preferences from viewing history and records programs without instruction from the viewer.

More recently cable and satellite access have allowed viewers to begin interacting with their television more actively. On-demand programming allows viewers to control how programming is streamed to them and when. Selecting icons from menus using the remote is now possible. Programming content has also become available from many new non-broadcast sources including YouTube, Hulu.com, DVDs, handheld devices and in-flight/in-seat entertainment.

This viewer access and control makes it possible to provide a new level of viewer interaction where viewers can not only rewind and pause programming, but can select items of interest from the screen. Viewers may now interact with their television at a level that allows selection of on-screen icons or interactive tags. Tags may be images that are part of an overlay to programming. Some tags may be non-interactive. While a movie is playing on the television screen, an icon related to another program that will be scheduled at a later time may appear proximate to a screen border.

Tags and icons may be related to or associated with the on-screen programming. On a news program a business commentator may be explaining a company's product and simultaneously a bar on the side of the screen is reporting current stock market activities for the company. Some kinds of tags and icons may allow limited viewer interaction. The viewer may be able to bring up a channel guide and scroll and select items in the channel guide while programming continues to play in a portion of the screen.

Fully interactive tags provide a much wider range of programming options including changing programming flow or accessing commercial or knowledge content on selecting an icon. But clicking on an on-screen icon may stop or interrupt the current programming to present content associated with the icon or tag. This is disruptive to the viewers continuity and concentration. When watching a basketball game or a movie, a viewer is less inclined to interrupt their current viewing to watch commercial content. A preferred method may be to allow a viewer to select an icon and have the commercial content appear at a later, less disruptive interval.

A less disruptive interval for presenting viewer requested information may be after the current entertainment programming. Content associated with the selected icon may be scheduled in relation to commercial breaks. A set or block of commercials may be queued for presentation during pauses in entertainment programming and clicking the icon may change the queue order and content to include the associated commercial content of the commercial block.

The first commercial seen or the last commercial seen in the block may be the icon associated commercial content. Other commercials already in the queue may be rescheduled to be played before or after the icon associated commercial content. The queue may be prioritized and some scheduled commercial content may not be played as a result of clicking the icon. The selected commercial may be played as the last commercial in a commercial block. This may maintain viewer interest in the intervening commercials.

Commercials queued for presentation may be reordered or resequenced based on the selected icon to present content related and complementary to the icon associated content. Viewer selections may be included in a viewer profile with selection history. The custom profile may include more personal information related to parameters such age, sex, career, interests and family size.

Tags or icons may appear proximate to the programming border and appear as a scrolling banner, a pop up banner, a pop up in the corner or a side border. Icons may also be part of the programming. Objects that appear in the programming, for example automobiles, clothing, jewelry, buildings, actors, may be selectable icons. Selectable icons may be avatars that change position on the screen.

Selecting an icon may bring content on-screen as a banner, border or some other method. The content may appear immediately or may be scheduled for later. For example clicking on an on-screen actress may result in information appearing on-screen as a scrolling banner that lists other movies the actress appears in. Clicking on content in the scrolling banner may queue additional content to appear at a later time. The content may include an opportunity to order other movies the actress appears in.

One or more viewer selectable icons and content associated with the icon may comprise an entertainment capsule. Entertainment capsule content may not be primarily commercial in nature. The content may also be of an educational or entertainment nature. The viewer may anticipate the selected content such that the viewer is willing to watch the commercial segments sequenced after the current programming segment in which the icon appears in order to view the following entertainment capsule

In another embodiment, in response to clicking on the icon a second icon may be displayed during the commercial block. The viewer may click the second icon to display associated content after the current commercial so that the viewer watches at least one commercial before the additional content.

This description may include a method of inserting an entertainment capsule with a viewer selectable icon and content into interactive programming which includes entertainment segments and commercial segments configured to be delivered to a viewer. The method may comprise associating the viewer selectable icon with content of one entertainment segment and sequencing the entertainment segments and the commercial segments at a headend to create at least a portion of the programming. The method may further include delivering the programming to a viewer display and displaying the viewer selectable icon simultaneously with the content of the one entertainment segment. On viewer selection of the viewer selectable icon the method may include sequencing the programming at the headend such that in order and without interruption: first the balance of the one entertainment segment is delivered to the viewer; then a plurality of commercial segments are delivered; and then the entertainment capsule content is delivered.

Associating the viewer selectable icon with content of one entertainment segment may be independent of any profile of the viewer which may have been defined at least in part on previous selections by the viewer. The icon may be portrayed as an avatar that changes position on the screen.

While the words “television” and “display” may be used in the following examples, is is used for the purpose of illustration. The following disclosure applies to many different kinds of content dissemination and display techniques including computers and hand held devices. Examples include cable, satellite, internet applications such as YouTube, Hulu.com and ABC.com, mobile applications, theaters with interactive features, airline inseat media presentation and music videos among others. While on-demand video may be used in some examples, the disclosure applies to broadcast and projecting or any other method of preparing, transmitting, presenting and displaying video.

In addition the terms pointing, clicking and selecting may be equivalent terms in this disclosure. The terms delivery, stream and display may all be essentially equivalent and include and describe transmitting segments comprising programming from a headend to an interactive viewer system.

The response to selecting tags is not limited to commercials. Other responses may include receiving coupons, interactive games, entertainment capsules, polling, questionnaires and rich banner advertisements among others.

### BRIEF DESCRIPTION OF FIGURES

FIG. 1 shows a television with display, a viewer with a remote and a queue.

FIG. 2 shows a programming system including a headend.

FIG. 3 shows a television with display, a viewer with a remote and a queue.

FIG. 3A shows a queue and associated functions.

FIG. 3B shows a queue with a commercial block and entertainment capsule content.

FIG. 4 shows a display with a tag and a queue.

FIG. 5 shows a timeline with entertainment segments, commercial segments, entertainment capsule content and a queue.

FIG. 5A shows a timeline with entertainment segments, commercial segments, entertainment capsule content and a queue.

FIG. 5B shows a timeline with an entertainment segment and entertainment capsule content.

FIG. 6 shows a television with an entertainment segment, selectable avatars, a cursor and a viewer with a remote.

FIG. 6A shows a television with an entertainment segment, selectable avatars, a cursor and two viewers with two remotes.

FIG. 6B shows a television displaying entertainment capsule content with viewer scores, selectable avatars, a cursor and two viewers with two remotes.

FIG. 7 is a flow chart of a method for inserting an entertainment capsule into programming.

### DESCRIPTION

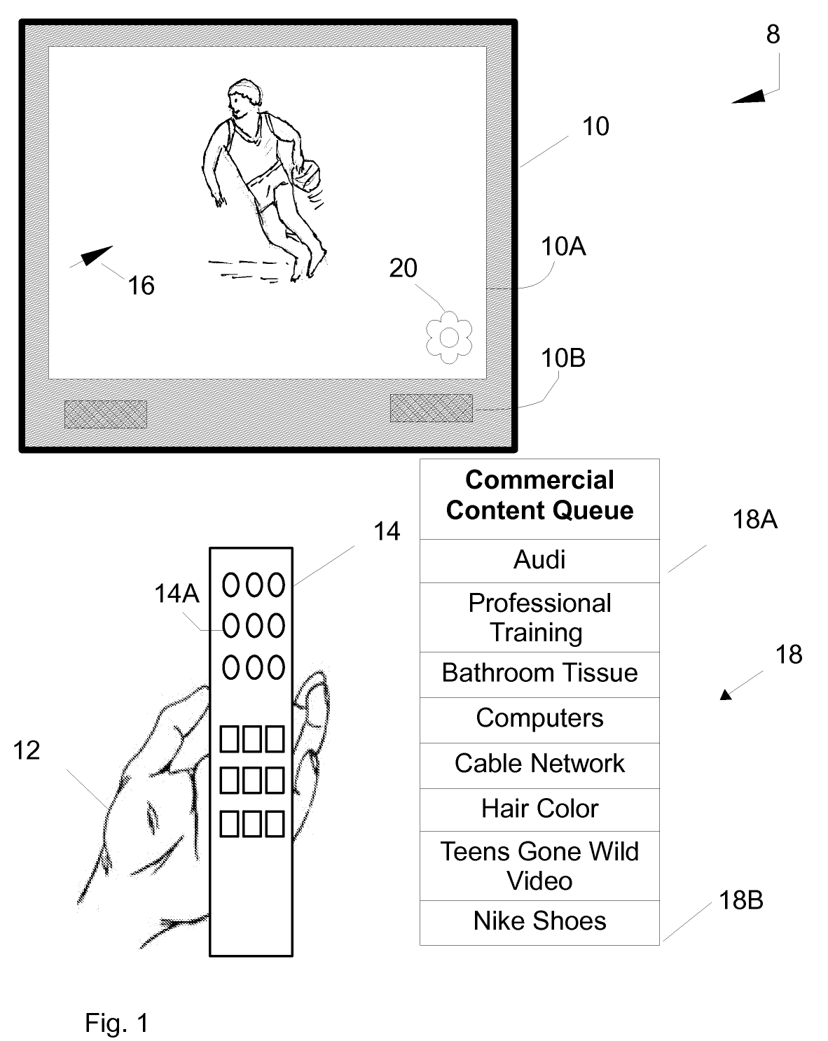

FIG. 1 shows an interactive video system 8 including a television 10 with a screen 10A and a viewer 12 with a remote 14. Remote 14 may have one or more inputs 14A. Screen 10A of television 10 further displays a cursor 16. Cursor 16 may change position in screen 10A in response to input at remote 14. Interactive video system 8 further includes a commercial content queue 18 shown here as a sequential list of commercial segments or entries. The first entry in queue in this example is shown as an automobile commercial 18A.

Screen 10A further displays an icon or avatar or tag 20. Tag 20 may be a scrolling banner, a side border with content, a corner logo or a portion of the displayed screen that can be selected and/or differentiated by viewer 12 using remote 14. Tag 20 may be configured as a viewer selectable animated avatar 20A and may move across screen 10A without viewer input. Television 10 may further include speakers, microphone and/or controls 10B.

Remote 14 may be wired or wireless. Remote 14 may include acceleration detection systems such that cursor 16 moves on screen 10A in response to accelerations of remote 14 in one, two or three dimensions. Remote 14 may be embodied as a voice response system. Cursor 16 may move on screen 10A and select tag 20 in response to spoken commands from viewer 12. Spoken commands may be received at microphone 10B. Cursor 16 may move on screen 10A in response to selections at remote input 14A by viewer 12. Cursor 16 may not be displayed at all times during viewing and may become visible in response to input at remote 14. Selecting tag 20 may not involve cursor 16. Tag 20 may be selected using buttons on remote 14 that highlight different icons on the screen sequentially or buttons that select any available icon or other inputs.

Display 10A may display entertainment segments 22, commercial segments 24, entertainment capsules 26 and commercial blocks 28 all scheduled by a programming system 30 as programming 30A. A subset of entries of queue 18 or a set of commercial segments 24 may comprise a commercial block 28 and may be displayed on screen 10A before, after or between entertainment segments 22. Entertainment capsule 26 may include one or more tags, icons or avatars 20 and entertainment capsule content 26A.

Queue 18 may be a list of references to discrete content units such as commercial segments 24 and entertainment capsule content 26A and may not be visible to viewer 12. Queue 18 may be accessed at a headend by a network in scheduling programming 30A for a selected channel. At appropriate times during programming, the programming may be paused and commercials may be presented in the order listed in queue 18. The first entry of queue 18 in this example is entry 18A, a commercial for an automobile. Last shown in the queue is an entry 18B for sports shoes.

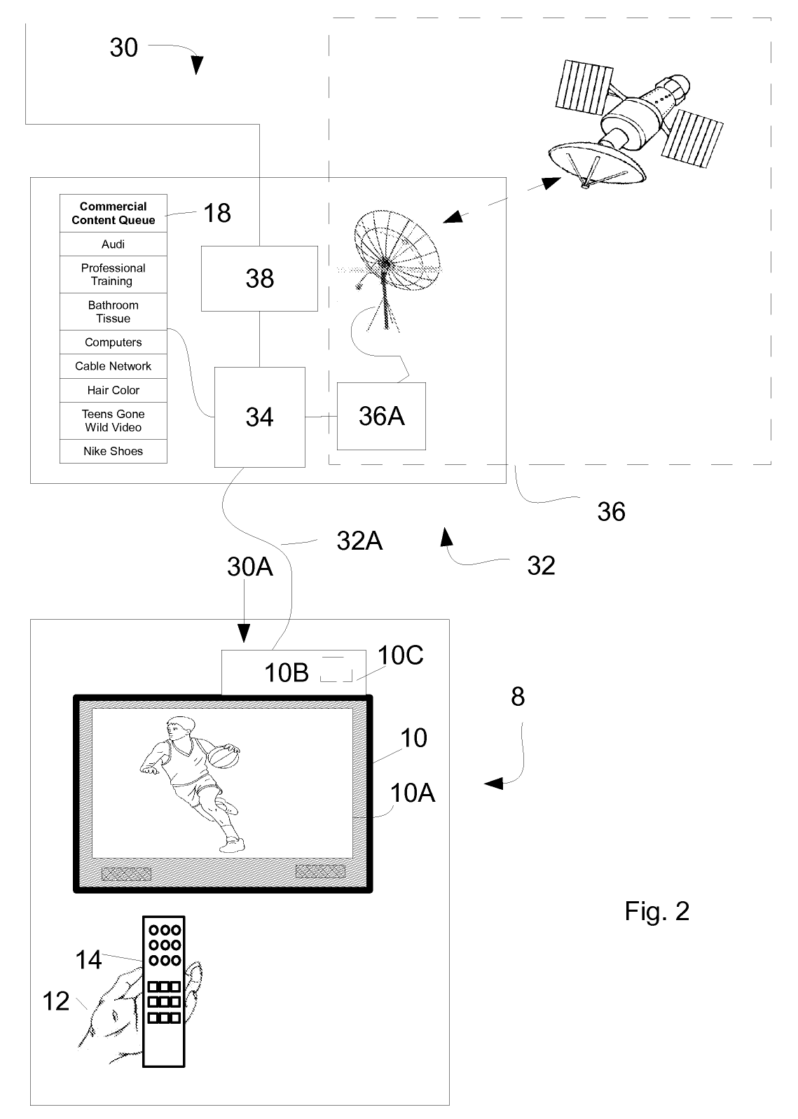

FIG. 2 shows an example programming system 30 for delivering programming 30A including headend 32 that may include queue 18, programming controller 34, satellite signal means 36 including satellite signal controller 36A for collecting signals transmitted by satellite, terrestrial signal means 38 for collecting signals sent by cable, microwave or other non-satellite means which may include local programming. Satellite signal means 36 and terrestrial signal means 38 may carry signals with entertainment segments 22, commercial segments 24 and entertainment capsules 26.

Segments comprising programming 30A may be sequenced and scheduled by programming controller 34 to present segments at scheduled times. Programming controller 34 may access queue 18 in scheduling commercial segments 24. Multiple channels may be combined at headend 32 so as to present several parallel channels selectable by viewer 12. FIG. 2 also includes interactive video system 8 similar to FIG. 1 including television 10 with screen 10A viewer 12 and remote 14. Viewer 12 is watching programming 30A delivered from headend 32 on a selected channel. Programming 30A may be delivered to interactive video system 8 by transmission means 32A. Transmission means 32A may be a video cable, an Internet cable a satellite link or any other means for video delivery. The configuration and functioning of programming system 30 and headend 32 is well understood by those skilled in the art and will not be presented in detail here.

Interactive video system 8 may further include a video box 10B that may handle functions associated with digital signals and channel selection. Video box 10B may also include memory 10C shown as a dotted line box in video box 10B.

In an alternative configuration sequencing for programming 30A may occur at least in part at video box 10B. Commercial segments 24, entertainment capsules 26, entertainment segments 22 and queue 18 may be stored in memory 10C. Video box 10B may respond to commands from viewer 12 using remote 14. Video box 10B may be operationally connected to television 10 and transmission means 32A.

Associating entertainment capsule icon 20 with entertainment segments 22 may include connecting an aspect of the entertainment segment audio or video content with an aspect of entertainment capsule content 26A. For example entertainment capsule content 26A may have information on an actress. Icon 20 may be associated with entertainment segment 22 when the actress appears on display 10A. This may be done in many different ways. In one example metadata may be associated with each scene in entertainment segment 22 that may describe the entertainment type (courtroom, sports, reality, drama), actors in the scene, the background of the scene, and other aspects such as whether it is a fight scene, a romantic scene or a chase scene. Each entertainment capsule 26 may also have metadata attached with similar descriptions for determining appropriate association or placement of entertainment capsule icon 20.

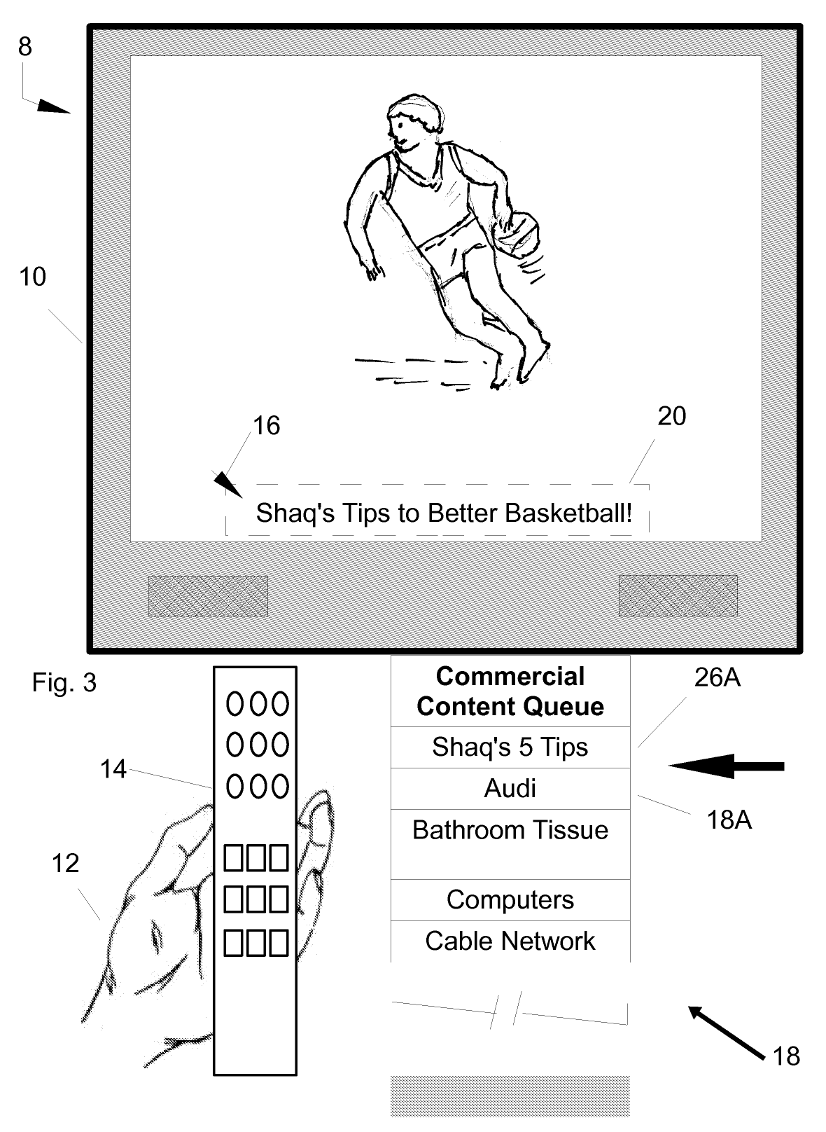

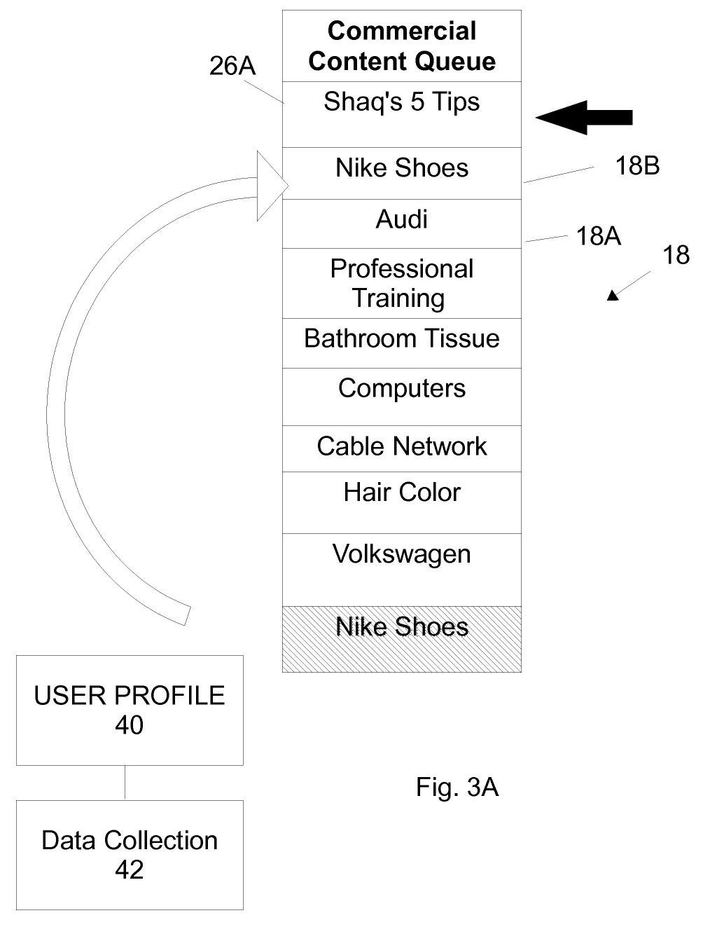

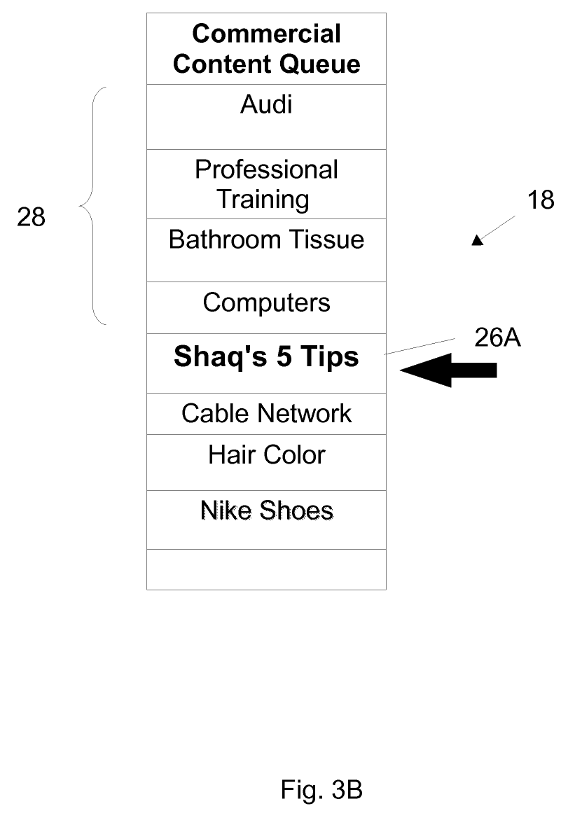

FIG. 3 is another view of interactive television system 8 again with television 10, viewer 12, remote 14, screen 10A displaying cursor 16 and queue 18. Television 10 is shown displaying an entertainment segment 22 as a basketball game. Also displayed is tag 20 at the bottom of screen 10A. Here tag 20 is represented as text at the bottom of screen 10A that reads “Shaq's 5 tips to better basketball!”

Viewer 12 using remote 14 may move cursor 16 over tag 20. In response the appearance of tag 20 may change to indicate it is selectable. Viewer 12 may be able to select tag 20 using remote 14 by moving cursor 16 over tag 20 or a portion of tag 20 and activating input 14A on remote 14. Alternatively, selecting tag 20 may be done by pressing a “select” input 14A on remote 14 or by “tabbing” through selectable icons with remote 14 and then pressing a “select” input 14A on remote 14.

Selecting tag 20 may result in new selected entertainment capsule content 26A being inserted in queue 18. Entertainment capsule content 26A in this example may include content of Shaquille O'neal presenting tips to playing better basketball. This presentation may include using a specific brand of basketball or a specific brand of shoe. After the entertainment capsule content 26A is displayed, the next commercial related to entry 18A in queue 18 may play, in this example the Audi commercial 18A previously at the top of the list.

The order of queue 18 may be further modified by selecting another commercial from queue 18 to follow entertainment capsule content 26A. FIG. 3A further includes a viewer profile 40 and a data collection system 42. Again, on clicking tag 20, entertainment capsule content 26A is entered at the top of queue 18.

Here commercial 18B for Nike shoes is moved to a position in queue 18 after entertainment capsule content 26A. This may be a function of viewer profile 40 that may predict likely interests of viewer 12. Interactive video system 8 may determine that viewer 12 in selecting tag 20 will be likely to have an interest in sport apparel such as entry 18B. Viewer profile 40 may be generated as a function of one or more selections of tags by viewer 12. Viewer profile 40 may be generated as a function of one or more selections of tags 20 by multiple viewers of remote 14. Viewer profile 40 may be generated by data collection system 42 over many sessions and many tag selections. Viewer profile 40 may be located at headend 32. FIG. 3B is another representation of queue 18 of FIG. 3. FIG. 3B also includes a designation of the first set of commercial segments as commercial block 28. Selecting tag 20 may result in new selected entertainment capsule content 26A again being inserted in queue 18. Entertainment capsule content 26A in this example may be sequenced at the end of commercial block 28. Viewer 12 may anticipate the entertainment capsule content 26A they selected and may be more inclined to view intervening commercials.

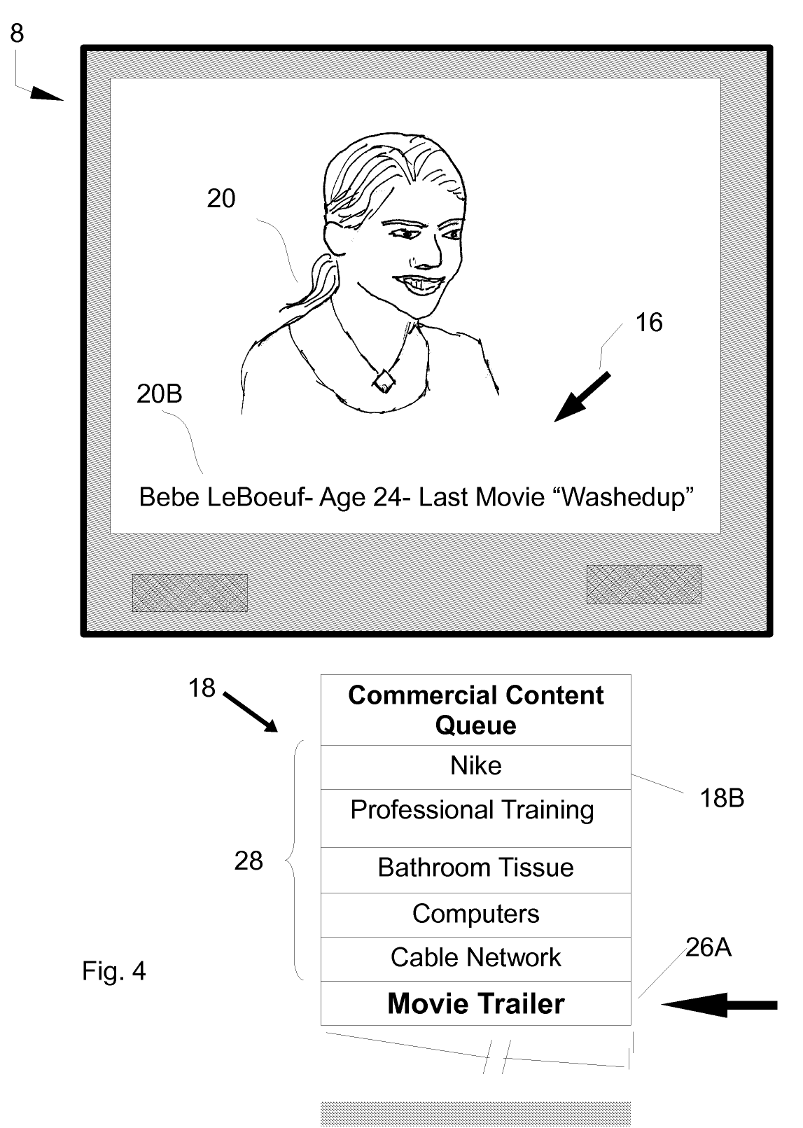

FIG. 4 again shows television 10 displaying cursor 16 on screen 10A and tag 20. Here tag 20 is an object displayed as part of programming. In this case tag 20 is an actress. A portion of screen 10A occupied by the actress may be differentiated to function as a tag. Positioning cursor 16 over actress tag 20 may again result in a display change indicating tag 20 is selectable. Here an adjunct tag 20B is displayed on moving cursor 16 over tag 20. Text of adjunct tag 20B reads “Bebe Le Boeuf—age 23—last seen in ‘Washedup’.” Clicking on tag 20 or selecting tag 20 may result in entertainment capsule content 26A related to the actress being added to queue 18 at the end of commercial block 28. Here entertainment capsule content 26A is an advertisement for “Washedup” which starred Bebe Le Boeuf. Alternatively, adjunct tag 20B in the form of text may be displayed after selecting tag 20. Alternatively, entertainment capsule content 26A may not have any commercial content and only actor information.

In another example tag 20 could be a monument or a building. Rolling the cursor over the building or monument may result in information being displayed as to the history of the monument or architect of the building. Clicking on tag 20 in this example may add entertainment capsule content 26A including travel information to the location of the monument or building into any of several positions in queue 18.

Viewer 12 may be able to bookmark information associated with tag 20. For example, viewer 12 accessing media through in-seat entertainment on an overseas flight may click on icon 20 associated with a temple near a destination for viewer 12. Clicking on icon or tag 20 may sequence more information on the temple for later viewing. Viewer 12 may bookmark the information for later access from another location. Viewer 12 may have the information sent to an email address that may be accessed later at the destination.

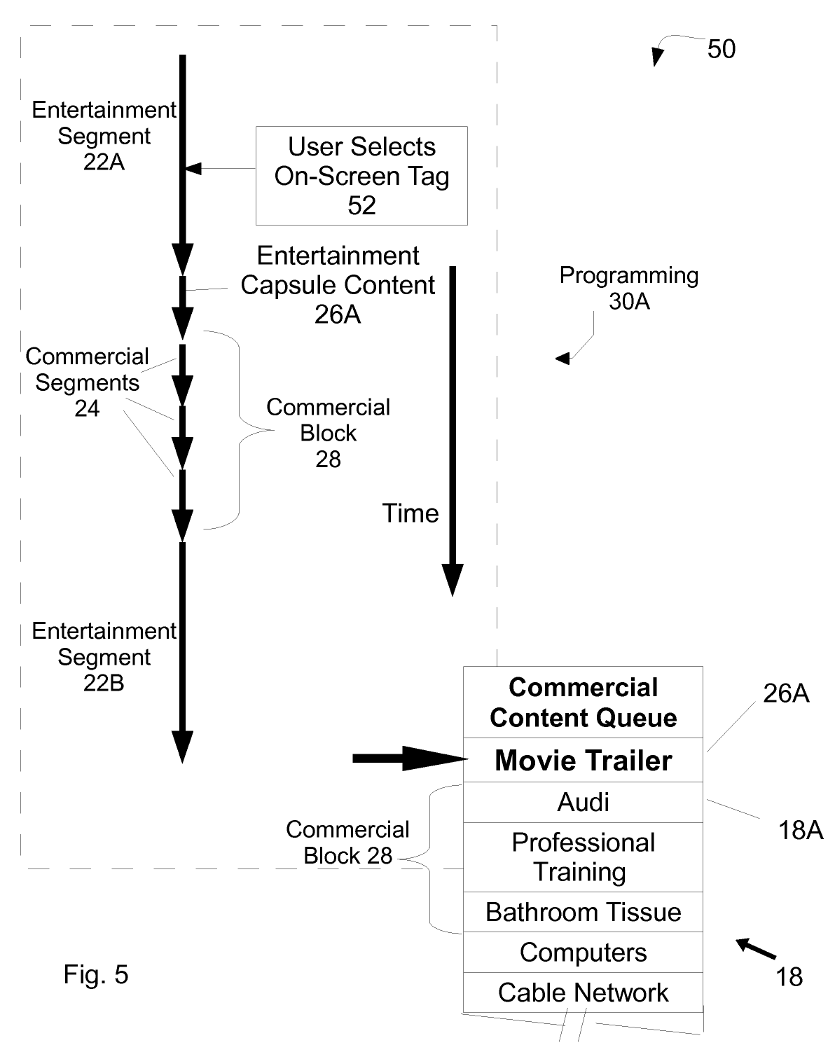

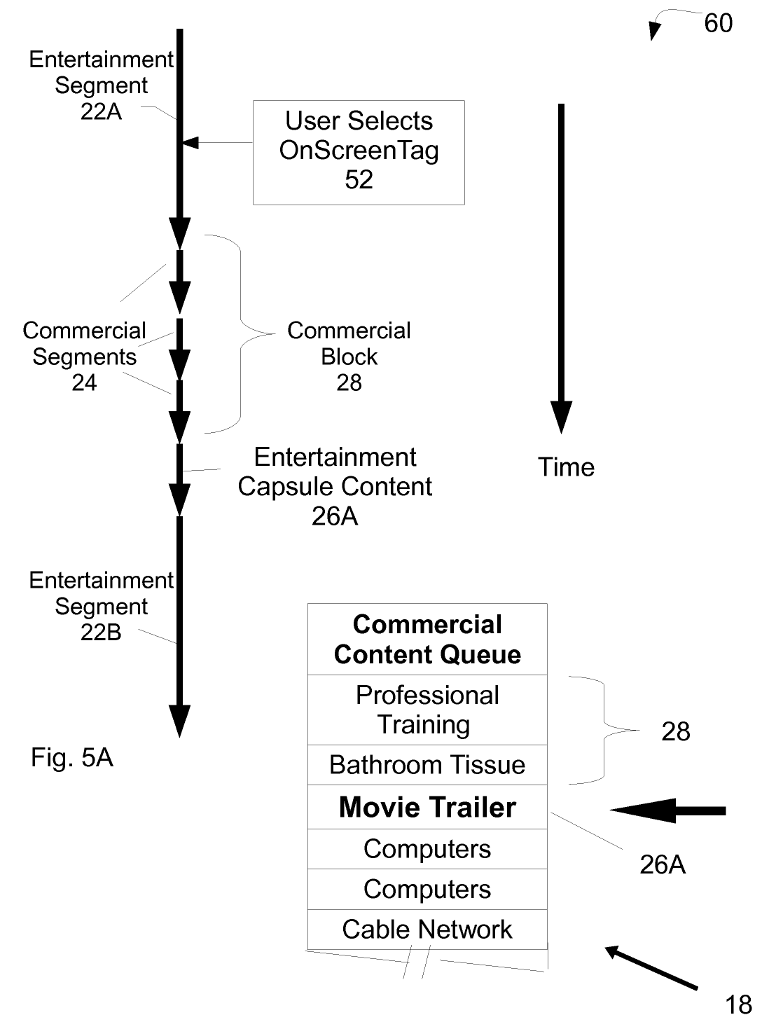

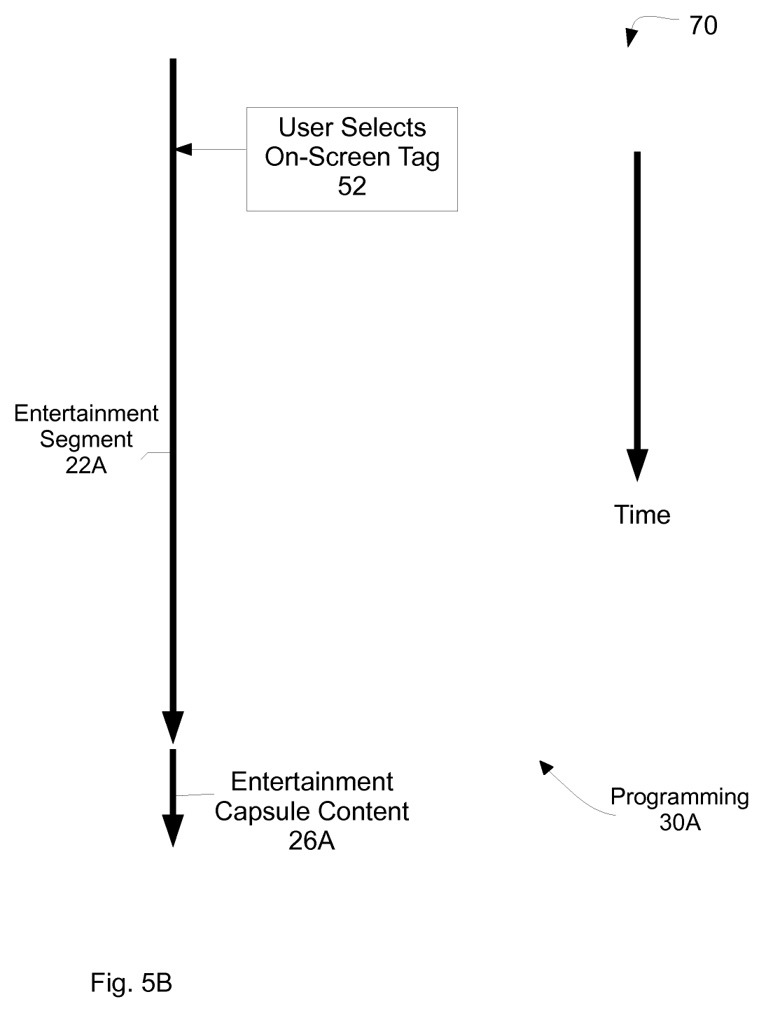

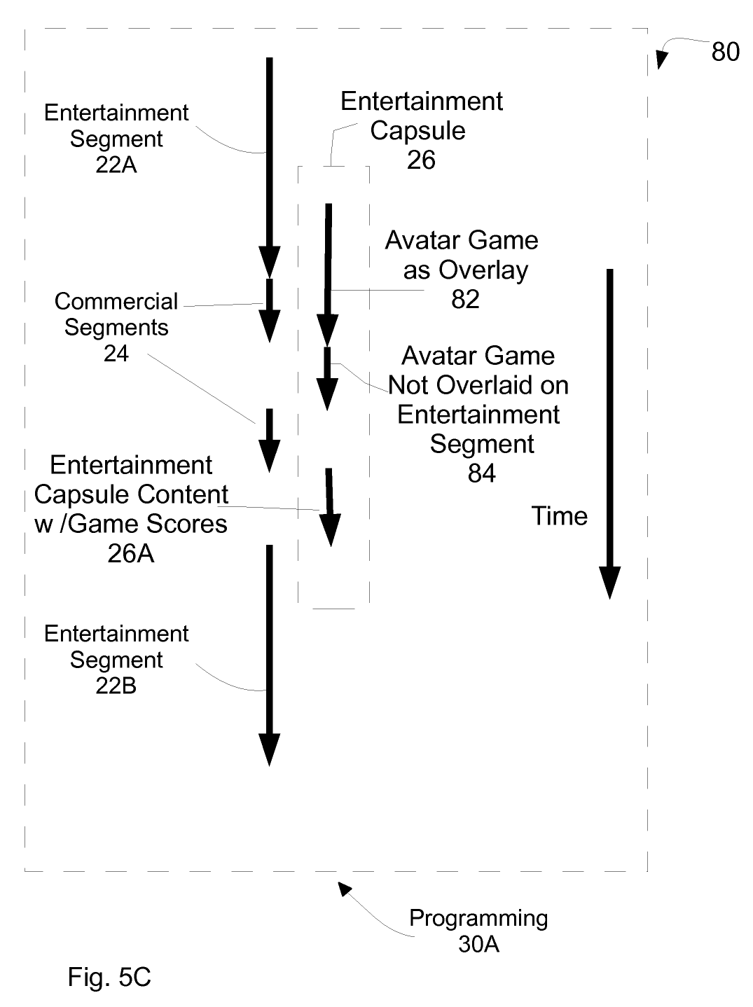

FIG. 5 is a timeline 50 related to execution of programming related to interactive video system 8. Timeline 50 includes commercial block 28 including one or more commercial segments 24, entertainment segment 22A, entertainment segment 22B displayed subsequently to entertainment segment 22A. FIG. 5 further includes queue 18 with entertainment capsule content 26A related to FIG. 4. Referring simultaneously to FIG. 5 and FIG. 4, viewer 12 may select tag 20 as represented by the actress displayed on screen 10A at step 52 during entertainment segment 22A. Entertainment capsule content 26A may be inserted in queue 18 at the end of entertainment segment 22A in response to selecting tag 20.

On the viewer selecting tag 20 the balance or remaining portion of entertainment segment 22A is delivered to viewer 12 on display 10A, entertainment capsule content 26A may be selected from queue 18 and a movie trailer as entertainment capsule content 26A may be delivered to viewer 12 and displayed on screen 10A. Subsequently entry 18A is selected from queue 18 and an Audi commercial is delivered and presented on screen 10A along with other commercial segments of commercial block 28. When all the scheduled commercials of commercial block 28 are delivered and presented, entertainment segment 22B may be presented on screen 10A.

Alternatively, entertainment capsule content 26A may be sequenced in queue 18 to be presented at the end of commercials in commercial block 28. FIG. 5A is a timeline 60 similar to timeline 50 and again includes commercial block 28 including one or more commercial segments 24, entertainment segment 22A, entertainment segment 22B displayed subsequently to entertainment segment 22A. Displaying entertainment capsule content 26A after commercial block 28 may cause viewer 12 to watch commercials of commercial block 28 in anticipation of viewer selected entertainment capsule content 26A. Commercial block 28 may include more or fewer commercial segments 24 than those indicated in queue 18.

Alternatively, entertainment capsule content 26A may be presented at the end of all programming. FIG. 5B is a timeline 70 similar to timeline 50 and again includes entertainment segment 22A and entertainment capsule content 26A. Programming 30A may include only one entertainment segment 22A such as a movie. Viewer 12 may select tag 20 from screen 10A during entertainment segment 22. In this example entertainment capsule content 26A is sequenced after the movie or entertainment segment 22A. In this example when entertainment segment 22 is completed entertainment capsule content 26A is presented at screen 10A.

Entertainment capsule 20 may be educational and may include adjunct tags 20B. Tag 20 may present a word along with several meanings selectable by viewer 12. Clicking on or selecting a meaning may result in entertainment capsule content 26A being sequenced in queue 18 to appear later with the correct answer. In between, one or more adjunct tags 20B including sentences may appear in commercial segments 24 that use the word that was presented in tag 20. Viewer 12 may be provided the opportunity to change the answer. Other educational icons may appear related to geography or math or current events and may operate in a similar manner.

Entertainment capsule 26 may include a game of knowledge associated with the content of a current entertainment segment 22. For example tag 20 may pose a trivia question with several selectable answers. Viewer 12 may select an answer on screen 10A using remote 14. The answer may be revealed as part of entertainment capsule content 26A. Entertainment capsule 26 or entertainment capsule content 26A may include rewards for a correct answer or special scores. Rewards may include coupons or free on-demand movies. Intervening commercial block 28 may include content associated with entertainment capsule 26. For example, a trivia question is posed in tag 20 during entertainment segment 22 with several possible answers. Commercial segments 24 displayed between entertainment segment 22 and entertainment capsule content 26A may display adjunct tags 20B that include clues as to the correct answer. Entertainment capsule content 26A may present the correct answer.

In another example entertainment capsule 26 may include a commercial block 28. Tag 20 may pose a question as to the content of current entertainment segment 22. The question may be “What type of airplane is James Bond flying?” Viewer 12 may select with remote 14 one of several selectable answers included in tag 20. In response to selecting an answer, each following commercial segment 24 may include adjunct tag 20B with content that is associated in some way with the question of tag 20. The background wall in commercial segment 24 for a brand of beer set in a bar and may have a picture of the airplane on the back wall of the bar. In next commercial segment 24 an airplane may fly overhead in the background with a banner displaying the airplane type. Finally entertainment capsule content 26A may provide the answer to the question.

In another example selecting or clicking on avatar 20A may involve a game of skill to coordinate cursor movement with movement of avatar 20A. Avatar 20A may be a tag configured as a character such as a roadrunner or coyote and may be selectable by viewer 12.

Viewer 12 may have to “catch” an elusive avatar 20A on screen 10A during entertainment segment 22. “Catching” avatar 20A by moving cursor 16 and selecting, clicking or pointing to avatar 20A may accrue points for viewer 12. Viewer 12 may additionally be provided the opportunity to “catch” avatar 20A during commercial segments 24 following entertainment segment 22.

After one or more commercial segments 24 in commercial block 28, during which viewer 12 is given the opportunity to catch avatar 20A and accrue points, a full hunt may ensue in entertainment capsule content 26A. The full hunt may involve selecting, clicking on or hovering over one or more displayed avatars 20A. Entertainment capsule content 26A may include a plurality of segments. A first entertainment capsule content segment 26B may include the full hunt and may be presented between commercial segments 24 of commercial block 28. A second entertainment capsule content segment 26C may display final scores for viewer 12.

Clicking or capturing avatar 20A may move the viewer to another game level that is presented as part of entertainment capsule 26. In another example, avatar 20A may be a roadrunner that intermittently runs across the bottom of the screen. Cursor 16 may be configured to appear as a coyote. Moving cursor 16 over roadrunner avatar 20A and clicking on it may accrue points for viewer 12.

In another example viewers may have the opportunity to click on one or more avatars 20A during entertainment segment 22 or commercial segment 24. Between sequential segments short hunts may occur where screen 10A is dedicated to multiple avatars 20A and scenes or scenarios with the opportunities for viewer 12 or multiple viewers to play more intently for a short period and gather additional points by clicking or selecting one or multiple avatars 20A. Avatar 20A may move across screen 10A or may appear and disappear from screen 10A. Differing speeds of movement or appearance of avatar 20A for different lengths of time may define complexity levels of the game.

FIG. 5C shows a timeline 80 similar to timeline 50 of FIG. 5 and includes entertainment segment 22A, entertainment segment 22B, commercial segments 24, entertainment capsule 26 and entertainment capsule content 26A. The avatar capture game may appear as an overlay in step 82 appearing simultaneously with entertainment segment 22A and a commercial segment 24. At step 84 display 10A is dedicated to the avatar capture game for this interval and is not overlaid on an entertainment segment 22 or commercial segment 24. Another commercial segment is delivered after step 84 and then entertainment capsule content 26A is delivered with scores for the avatar capture game. Viewer 12 may have their attention on the screen and be more willing to watch commercial segments 24 when the avatar capture game of entertainment capsule 26 is included. This sequencing is an example. Other sequences that perform a similar function fall within the scope of this disclosure.

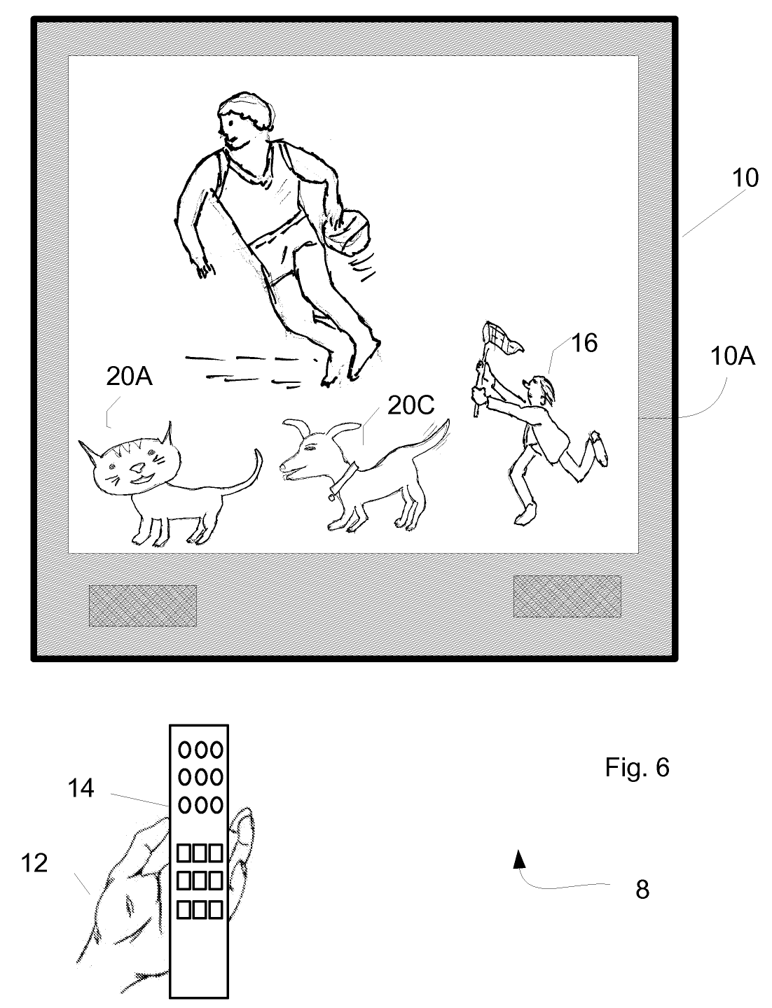

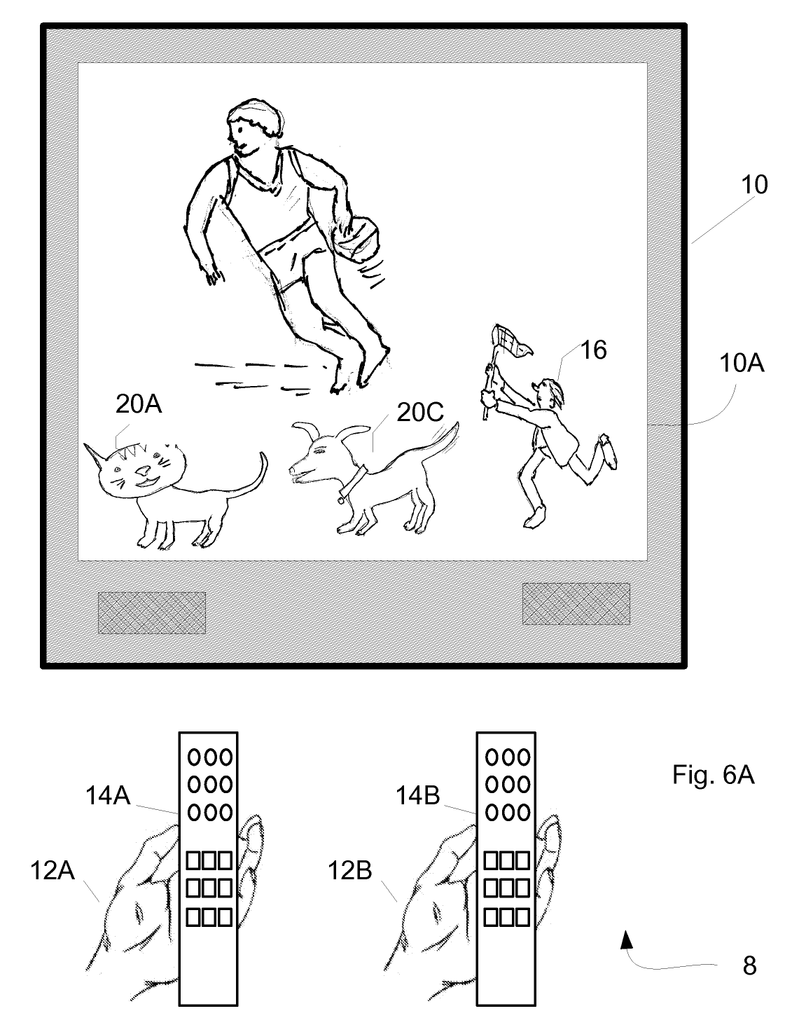

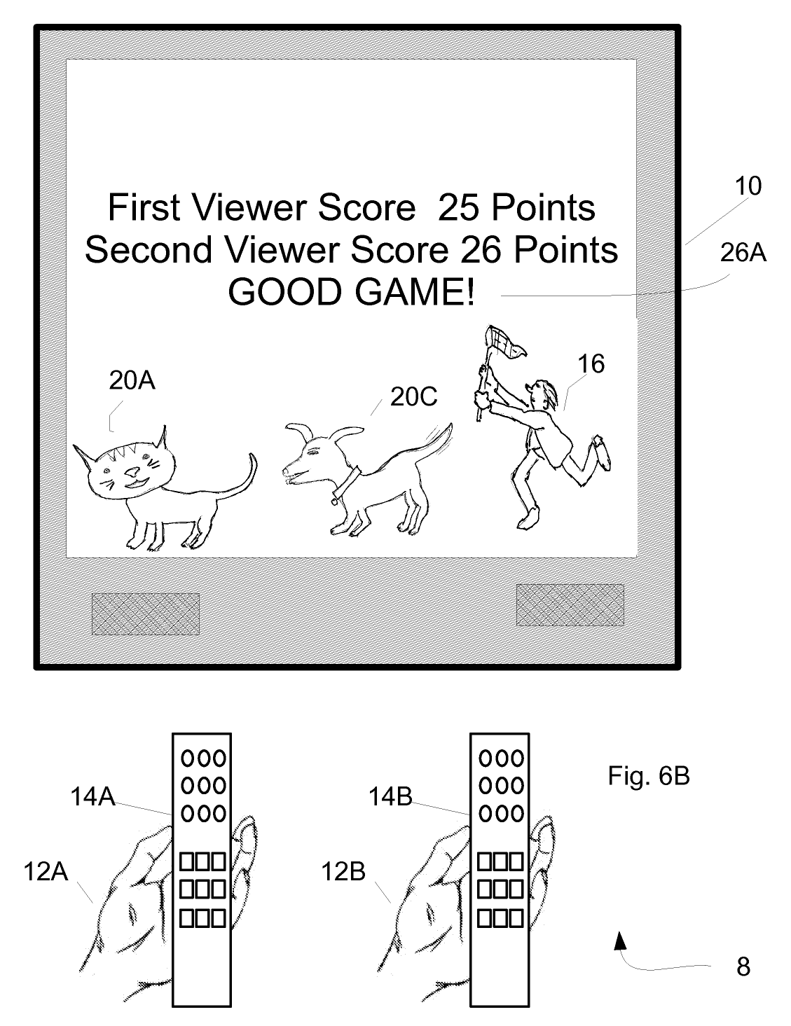

In another example the hunt may be more complex as illustrated in FIG. 6. FIG. 6A includes television 10 with screen 10A, displaying cursor 16, first avatar 20A, second avatar 20C, viewer 12 and remote 14. First avatar 20A may be a kitten and a second avatar 20C may be a dog. Cursor 16 may be configured to appear as a dog catcher. Viewer 12 may be responsible for catching the dog before it gets kitten avatar 20A and carries it off by its scruff. Kitten avatar 20A may appear on screen 10A frequently pursuing mundane activities such as napping, rolling over or cleaning itself. Dog avatar 20C may intermittently jump out and chase kitten avatar 20A without viewer input. Dog avatar 20C and kitten avatar 20A may move across the screen during these activities. Viewer 12 may be required to move cursor 16 using remote 14 over dog avatar 20C or between dog avatar 20C and kitten avatar 20A to protect the kitten. One avatar may be more attractive than the other. The game may continue while entertainment segments 22 and commercial segments 24 are displayed on screen 10A and/or between segments.

In another example, two viewers 12A and 12B may have separate remotes. System 8 may differentiate signals from separate remotes 14A and 14B. This may allow two viewers 12A and 12B to compete in clicking on avatars and icons. FIG. 6A illustrates another example of system 8 where viewer 12A and viewer 12B may accumulate separate scores. FIG. 6A includes television 10 with screen 10A, displaying cursor 16, first avatar 20A, second avatar 20C, first viewer 12A with first remote 14A and second viewer 12B with second remote 14B. Viewer 12A and viewer 12B may compete for scores. Opportunities to click on icons and avatars may continue during entertainment segments 22 and commercial segments 24 and scores for viewer 12A and viewer 12B may accumulate as goals are achieved.

Viewer 12, 12A or 12B may be able to select the appearance of specific avatars 20A or 20C from a menu of avatar figures. Viewer 12, 12A or 12B may be able to select the appearance of cursor 16 from a menu of avatar figures.

FIG. 6B includes television 10 with screen 10A, displaying cursor 16, first avatar 20A, second avatar 20C, first viewer 12A, second viewer 12B and remotes 14A and 14B. Screen 10A also displays entertainment capsule content 26A with scores for the first viewer 12A and second viewer 12B.

In another embodiment icon 20 may appear on screen 10A during entertainment segment 22 and icon 20 may be associated with entertainment capsule 26. Viewer 12 may click on icon 20. In response, after current entertainment segment 22, commercial segments 24 may be presented in a commercial block 28. During these commercial segments second adjunct tag or icon 20B may move across the screen. Clicking the adjunct tag or icon 20B may result in a reward of terminating commercial block 28 and initiating entertainment capsule 26. The first commercials in commercial block 28 may have intent viewer attention, increasing it's value.

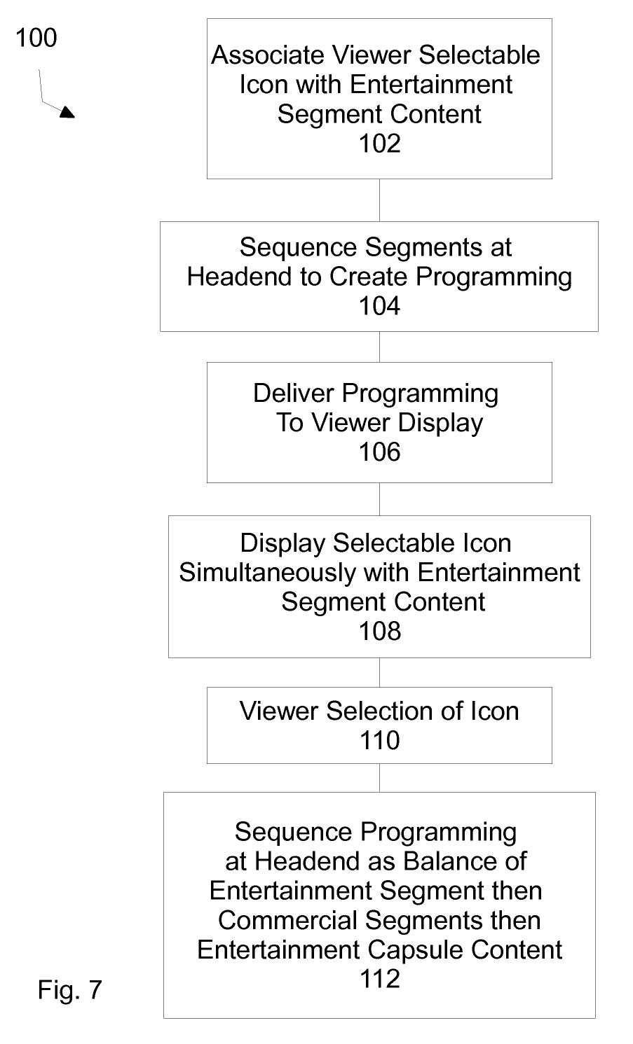

FIG. 7 shows a method 100 of inserting an entertainment capsule 26 with a viewer selectable icon and content in interactive programming including entertainment segments and commercial segments to be delivered to a viewer. The method may comprise associating the viewer selectable icon with content of one entertainment segment at step 102, sequencing the entertainment segments and the commercial segments at a headend to create at least a portion of the programming at step 104 and delivering the programming to a viewer display at step 106. The method may further comprise displaying the viewer selectable icon simultaneously with the content of the one entertainment segment at step 108 and on viewer selection of the viewer selectable icon at step 110. In response to viewer selection of icon 20 sequence the programming at the headend such that, in order and without interruption, first the balance of the one entertainment segment is delivered to the viewer, second a plurality of commercial segments are delivered and third the entertainment capsule content is delivered at step 112.

Associating the viewer selectable icon with content of one entertainment segment at step 102 may further include associating the viewer selectable icon with content of one entertainment segment independently of any profile of the viewer defined at least in part on previous selections by the viewer. The icon of steps 102,108 and 110 may be an avatar that changes position on the screen.

The described system and assemblies are examples and are not to be used as limitations. While basketball may be used as a programming example or specific characters for avatars, any programming presented in this context may fall within the scope of this disclosure. Any suitable configuration or combination of components presented, or equivalents to them that perform a similar function falls within the scope of this disclosure.

This disclosure may include one or more independent or interdependent inventions directed to various combinations of features, functions, elements and/or properties, one or more of which may be defined in the following claims. Other combinations and sub-combinations of features, functions, elements and/or properties may be claimed later in this or a related application. Such variations, whether they are directed to different combinations or directed to the same combinations, whether different, broader, narrower or equal in scope, are also regarded as included within the subject matter of the present disclosure. An appreciation of the availability or significance of claims not presently claimed may not be presently realized. Accordingly, the foregoing embodiments are illustrative, and no single feature or element, or combination thereof, is essential to all possible combinations that may be claimed in this or a later application. Each claim defines an invention disclosed in the foregoing disclosure, but any one claim does not necessarily encompass all features or combinations that may be claimed. Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

1. A method of inserting a viewer selectable icon and associated entertainment capsule content in interactive programming that includes one or more entertainment segments and one or more commercial segments comprising:
associating the viewer selectable icon with content of a first entertainment segment;
delivering the interactive programming from a headend to a viewer display where the headend includes:
a server with memory storing at least the one or more commercial segments and the entertainment capsule content;
a queue for sequencing delivery of at least the one or more commercial segments and the entertainment capsule content; and
a program manager that sequences the order of the queue;
displaying the viewer selectable icon simultaneously with the associated content of the first entertainment segment; and
in response to viewer selection of the viewer selectable icon the program manager sequencing the queue such that:
the balance of the first entertainment segment is delivered from the headend and displayed;
then at least one commercial segment is delivered from the headend and displayed; and
then the entertainment capsule content associated with the viewer selectable icon is delivered from the headend and displayed.

2. The method of inserting a viewer selectable icon and associated entertainment capsule content of claim 1 where associating the viewer selectable icon with the content of one entertainment segment is independent of any profile of the viewer defined at least in part on previous selections by the viewer.

3. The method of inserting a viewer selectable icon and associated entertainment capsule content of claim 1 where the icon is an avatar that moves across the viewer display.
